(19) United States
(12) Patent Application Publication
(10) Pub. No.: US 2009/0262417 A1
(43) Pub. Date: Oct. 22, 2009

(54) 193nm Immersion Microscope

(75) Inventors: Daniel G. Smith, Tucson, AZ (US); David M. Williamson, Tucson, AZ (US)

Correspondence Address: LAWRENCE R. OREMLAND, P.C., 5055 E. BROADWAY BLVD., SUITE C-214, TUCSON, AZ, 85711, US

(73) Assignee: Nikon Corporation, Tokyo (JP)

(21) Appl. No.: 12/423,725

(22) Filed: Apr. 14, 2009

Related U.S. Application Data
(60) Provisional application No. 61/045,930, filed on Apr. 17, 2008.

(51) Int. Cl. G02B 21/16; G02B 1/00

(52) U.S. Cl. 359/355

(57) ABSTRACT

New and useful concepts are provided for the objective portion of a liquid or solid immersion microscope are provided, that uses 193 nm light for illumination and imaging of a sample, and includes a liquid or solid immersion lens configuration. The illumination and imaging can be provided, e.g. with (a) a liquid immersion lens with a final objective lens element that comprises a lutetium aluminum garnet (LuAg) lens element, a barium lithium fluoride (BaLiF) lens element, or a fused silica lens element, and a liquid immersion layer that has an index of refraction that is equal to or greater than the index of refraction of water at a wavelength of approximately 193 nm, or (b) a solid immersion lens with a final objective lens element that has an index of refraction greater than or equal to the index of refraction of fused silica at a wavelength of approximately 193 nm.

### RELATED APPLICATION/CLAIM OF PRIORITY

This application is related to and claims priority from provisional application Ser. No. 61/045,930, filed Apr. 17, 2008, which provisional application is incorporated by reference herein.

### INTRODUCTION

The present invention provides a new and useful concept in microscopy, which uses 193 nm light for illumination and imaging of an object with a liquid or solid immersion objective. The invention provides a reduction in wavelength that is achieved by increased index of refraction of the liquid or solid immersion lens, which enhances the resolution.

More specifically, the present invention relates to a microscope that provides 193 nm light for illumination and imaging of an object, with a liquid or solid immersion lens. The illumination and imaging can be provided, e.g. with (a) a liquid immersion lens with a final objective lens element that comprises a lutetium aluminum garnet (LuAg) lens element, a barium lithium fluoride (BaLiF) lens element, or a fused silica lens element, and a liquid immersion layer that has an index of refraction that is equal to or greater than the index of refraction of water at a wavelength of approximately 193 nm, or (b) a solid immersion lens with a final objective lens element that has an index of refraction greater than or equal to the index of refraction of fused silica at a wavelength of approximately 193 nm.

According to one example of a microscope according to the principles of the present invention, the illumination and imaging of an object is provided with a liquid immersion lens with a final objective lens element of the liquid immersion lens that comprises a LuAg lens element and an immersion liquid that has an index of refraction greater than or equal to the index of refraction of water at a wavelength of approximately 193 nm (n≈1.43). Preferably, with a LuAg lens element, the index of refraction of the immersion liquid is about 1.65.

According to another example of a microscope according to the principles of the present invention, the illumination and imaging is provided with a liquid immersion lens with a final objective lens element that comprises a BaLiF lens element or a fused silica lens element, and an immersion liquid that has an index of refraction greater than or equal to the index of refraction of water at a wavelength of approximately 193 nm (n≈1.43).

According to still another examples of a microscope according to the principles of the present invention, the illumination and imaging is provided with a solid immersion lens having a final objective lens element that has an index of refraction greater than or equal to the index of refraction of fused silica at a wavelength of approximately 193 nm (n≈1.56).

Further features and objectives of the present invention will be further apparent from the following detailed description and the accompanying drawings.

### BRIEF DESCRIPTION OF THE DRAWINGS

FIG. 1 schematically illustrates the objective portion of a diffraction limited catadioptric high index liquid immersion microscope, with a LuAg final objective lens element near the object, according to the principles of the present invention;

FIG. 2 schematically illustrates the objective portion of a diffraction limited catadioptric water immersion microscope, with an objective design using a fused silica final objective lens element near the object, according to the principles of the present invention (the Rayleigh resolution of this objective is 86.7 nm);

FIG. 3 schematically illustrates illumination and imaging principles of a diffraction limited catadioptric solid immersion microscope objective design, using a LuAg solid immersion lens (SIL) as the final objective lens element near the object, according to the principles of the present invention (the Rayleigh resolution of this objective is 57.9 nm);

FIG. 4 is a table showing the practical resolutions of microscopes using 193 nm illumination, according to the principles of the present invention (Meniscus means that there is a single refracting element with a substantial working distance to the object); SIL means that there is a single refracting element that is also the solid immersion lens element; MSIL means that there is, in addition to the solid immersion lens element, a second refracting element; HIL means that there is a high index liquid used as the immersion liquid between the final lens element and the sample; and SiO₂+H₂O means that the final element is made of fused silica and that the immersion liquid is water).

FIG. 5 is an enlarged, fragmentary, schematic illustration of the objective portion of a liquid immersion microscope, according to the principles of the present invention; and

FIG. 6 is an enlarged, fragmentary, schematic illustration of the objective portion of a solid immersion microscope, according to the principles of the present invention.

### DETAILED DESCRIPTION

As described above, the present invention provides a new and useful concept in microscopy that uses 193 nm light for illumination and imaging, with a liquid or solid immersion lens. The invention provides a reduction in wavelength that is achieved by increased index of refraction of the liquid or solid immersion layer, which enhances the resolution. In this application, reference to a liquid immersion lens generally means a liquid immersion layer disposed between an objective lens element and the object, and reference to a solid immersion lens generally means a gap (that may be e.g. air or vacuum) disposed between an objective lens element and the object.

Also, it is believed initially useful to note that in this application, reference to 193 nm, or 193 nm light means light that is used with ArF (argon fluoride) lithography, and also includes light from solid state sources at substantially similar wavelengths as an ArF source.

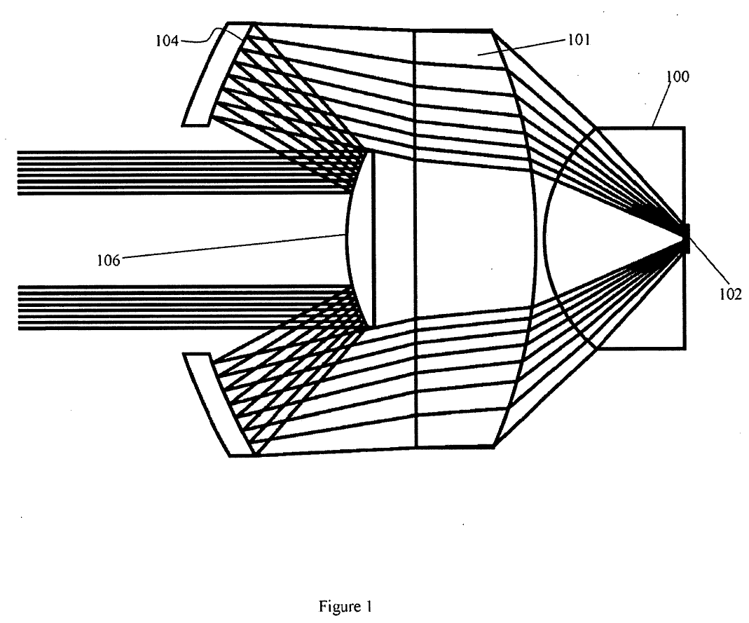

FIGS. 1-3 each schematically illustrates the illumination and imaging principles of an immersion microscope according to the present invention. Each of the illumination and imaging systems shown in FIGS. 1-3 employs an aspheric Schwarzchild type objective (that comprises reflecting surfaces 104, 106) with a pair of spherical refracting elements (100, 101) near the object 102. An immersion layer is provided between the objective lens element 100 and the object 102, as described further below.

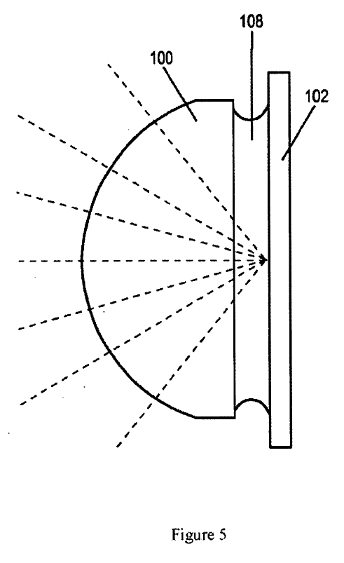

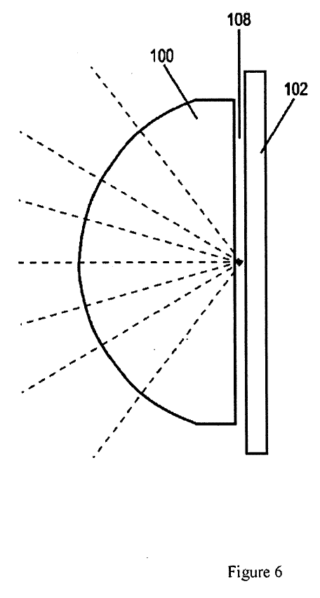

FIG. 5 is an enlarged, fragmentary schematic illustration of the objective portion of a liquid immersion microscope, with an immersion lens that comprises a layer of water 108 (that may have nano particles suspended therein) between the objective lens element 100 and the object 102, according to the principles of the present invention; and FIG. 6 is an enlarged, fragmentary, schematic illustration of a portion of a solid immersion microscope, with an immersion lens that comprises a gap 110 between the objective lens element 100 and the object 102, according to the principles of the present invention.

FIG. 1 schematically illustrates a diffraction limited catadioptric high index liquid immersion microscope objective design, using a LuAg objective lens element 100 near the object 102, and a liquid immersion layer 108 between the objective lens element 100 and the object 102. With a LuAg lens element with an index of refraction of about 2.14, and an immersion liquid with an index of refraction of about 1.65, the Rayleigh resolution, as given by equation 1 below, of this objective is 75.1 nm);

$$r = \frac{0.61 λ}{n sin θ} \qquad ( 1 )$$

where Lambda is the vacuum wavelength (which is 193 nm in this case), and wherein the sine of the ray angle is 0.95, while the index of refraction is that of the immersion material.

The illumination imaging is preferably provided with a liquid immersion lens (e.g. with the configuration as shown in FIG. 5) with a final objective lens element 100 that comprises a LuAg objective lens element, and an immersion liquid layer 108 (e.g. water that may have nano particles suspended therein) that has an index of refraction greater than or equal to the index of refraction of water at a wavelength of approximately 193 nm (1.43). As described above, with a LuAg final objective lens element 100, the index of refraction of the immersion liquid layer 108 is preferably about 1.65.

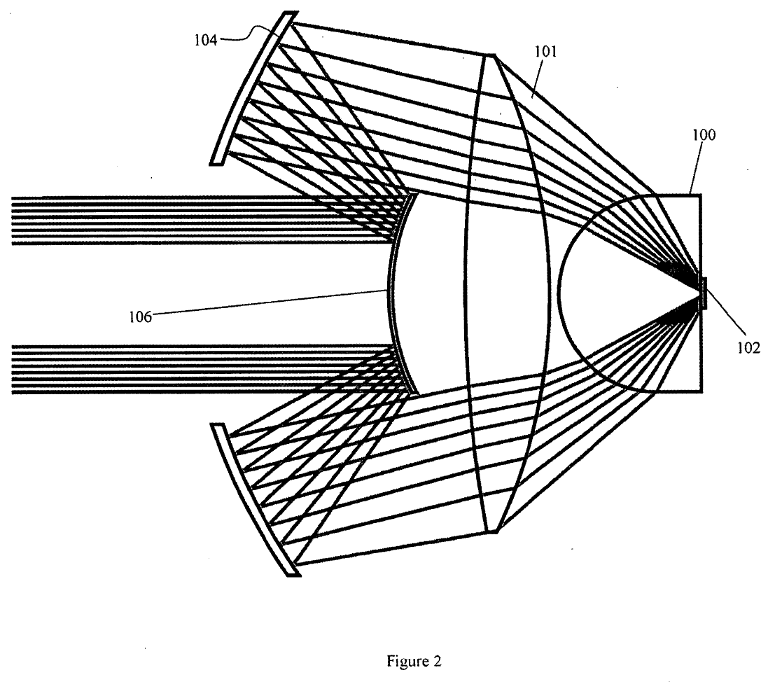

The illumination and imaging system of FIG. 2 illustrates a diffraction limited catadioptric water immersion microscope objective design, using a fused silica objective lens element 100 near the object 102. The Rayleigh resolution of this objective, as described by equation (1) above, is 86.7 nm. The imaging is preferably provided by a liquid immersion lens (e.g. with the configuration as shown in FIG. 5) with liquid immersion layer 108 between the final objective lens element 100 and the object 102, where the liquid immersion layer has an index of refraction greater than or equal to the index of refraction of water at a wavelength of approximately 193 nm (1.43).

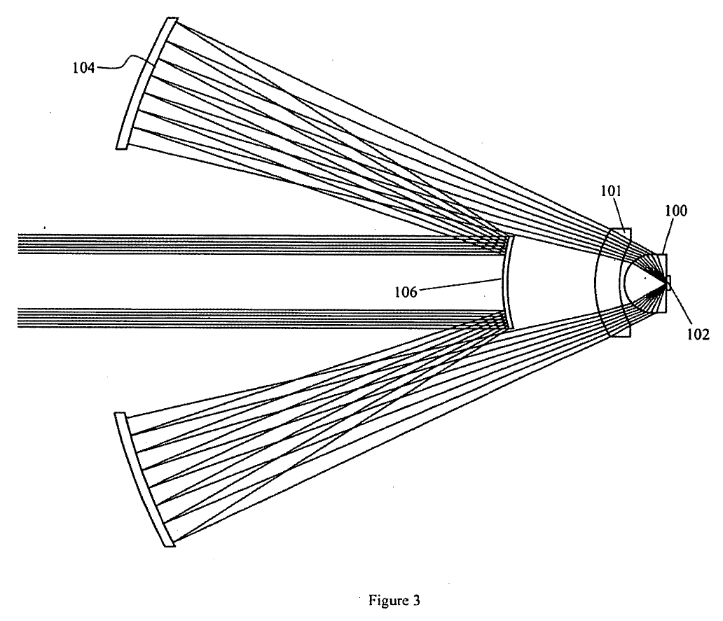

The illumination and imaging system of FIG. 3 illustrates a diffraction limited catadioptric solid immersion microscope objective design, using a LuAg solid immersion lens (SIL) 100 near the object 102. The Rayleigh resolution of this objective, as described by equation (1) above, is 57.9 nm. The illumination and imaging is preferably provided with a solid immersion lens (with a configuration as shown in FIG. 6) with a final lens element 100 that comprises a LuAg lens element, and an immersion gap 110 (which may be air or vacuum) between the lens element 100 and the object 102. Moreover, the objective can be provided with the immersion gap 110 and a final objective lens element that comprises a BaLiF lens element. Still further, the objective can be provided with the immersion gap and a final objective lens element 100 that comprises a fused silica lens element. In each of the foregoing solid immersion lens designs, objective lens element 100 has an index of refraction greater than or equal to the index of refraction of fused silica at a wavelength of approximately 193 nm (n≈1.56).

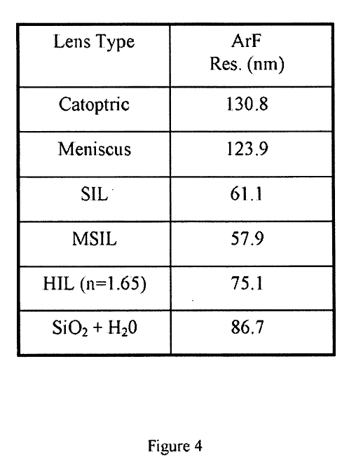

As will be appreciated by those in the art, the present invention provides a new and useful concept in immersion microscopy by applying certain specific technologies developed for 193 nm in lithography to microscopy. The illumination and imaging designs shown in the Figures are designed to produce enhanced resolution, as shown in the table of FIG. 4. FIG. 4 is a table showing the practical resolutions of microscopes using 193 nm illumination. Meniscus means that there is a single refracting element with a substantial working distance to the object. SIL stands for solid immersion lens. MSIL refers to the use of an additional refracting element with the SIL. HIL stands for high index liquid. Note that the ArF SIL, MSIL, and HIL refer to designs using LuAg. It is also possible and possibly preferable to use other materials including BaLif or SiO2, and other combinations of glass and liquids.

Thus, a microscope according to the present invention uses 193 nm light for the objective portion of the microscope with a liquid or solid immersion lens. The objective can be provided with a liquid immersion lens with a final objective lense element that comprises a LuAg lens element, and an immersion liquid that has an index of refraction greater than or equal to the index of refraction of water at a wavelength of approximately 193 nm (1.43). Moreover, the objective can be provided with a liquid immersion lens with a final objective lens element that comprises a BaLiF lens element or a fused silica lens element, with an immersion liquid has an index of refraction greater than or equal to the index of refraction of water at a wavelength of approximately 193 nm (n≈1.43). Still further, the objective can be provided by a solid immersion lens with a final objective lens element that has an index of refraction greater than or equal to the index of refraction of fused silica at 193 nm (n≈1.56).

Finally, it should be noted that in a microscope objective that uses a pair of lens elements of a high index crystal (e.g. LuAg or BaLiF lens elements), it may be necessary to compensate intrinsic cubic birefringence of that lens element. In such a case, the crystal axes of the lens elements would be oriented in such a way as to minimize the effects of the intrinsic cubic birefringence. In addition, it should be noted that the wavelength within the immersion medium is equal to the vacuum wavelength divided by the index of refraction of the medium. Also, it should be noted that it may be desirable to provide the illumination and imaging light (e.g. the light to the left of the refractive element 101 in FIGS. 1-3) in an environment that has been purged of nitrogen.

Accordingly, the foregoing description and drawings show how the microscopy principles of the present invention uses 193 nm light for illumination and imaging of an object with a liquid or solid immersion objective. The invention provides a reduction in wavelength that is achieved by increased index of refraction of the liquid or solid immersion lens, which enhances the resolution. With the foregoing description in mind, the manner in which the principles of the invention can be used with various microscopy designs that use 193 nm light for illumination of an object with a liquid or solid immersion objective, will be apparent to those in the art.

1. A microscope that provides 193 nm light for illumination and imaging of an object, with a liquid or solid immersion lens as the final objective lens element nearest the object.

2. A microscope as defined in claim 1, wherein the illumination and imaging is provided with a solid immersion lens with a final objective lens element that comprises a LuAg lens element.

3. A microscope as defined in claim 1, wherein the illumination and imaging is provided with a solid immersion lens with a final element that comprises a BaLiF lens element.

4. A microscope as defined in claim 1, wherein the imaging is provided with a solid immersion lens with a final element that comprises a fused silica lens element.

5. A microscope as defined in claim 1 where the illumination and imaging is provided with a liquid immersion lens with a final objective lens element that comprises a LuAg lens element, and an immersion liquid that has an index of refraction greater than or equal to the index of refraction of water at a wavelength of approximately 193 nm (1.43).

6. A microscope as defined in claim 5 where the index of refraction of the immersion liquid is approximately 1.65 at 193 nm.

7. A microscope as defined in claim 1 where the illumination and imaging is provided with a liquid immersion lens with a final objective lens element that comprises a BaLiF lens element or a fused silica lens element, and an immersion liquid that has an index of refraction greater than or equal to the index of refraction of water at a wavelength of approximately 193 nm (1.43).

8. A microscope as defined in claim 1 where the illumination and imaging is provided with a solid immersion lens with a final objective lens element that has an index of refraction greater than or equal to the index of refraction of fused silica at a wavelength of approximately 193 nm (1.56).
